(19) United States
(12) Patent Application Publication
(10) Pub. No.: US 2002/0166915 A1
(43) Pub. Date: Nov. 14, 2002

(54) Cable reel

(75) Inventor: Tomoyuki Sakata, Nagoya-shi (JP)

Correspondence Address: OLIFF & BERRIDGE, PLC, P.O. BOX 19928, ALEXANDRIA, VA, 22320, US

(73) Assignee: Autonetworks Technologies, Ltd., Nagoya-shi (JP)

(21) Appl. No.: 10/142,202

(22) Filed: May 10, 2002

(30) Foreign Application Priority Data
May 14, 2001 (JP) 2001-143118

(51) Int. Cl. B65H 75/38; H01R 39/00

(52) U.S. Cl. 242/388; 439/13

(57) ABSTRACT

In a cable reel, a stationary body and a movable body are combined together to define an annular hollow section. A guide member is disposed in the annular hollow section, the guide member including a C-shaped ring and plural rollers. A flat cable is wound round an inner circumferential passage and wound round an outer circumferential passage, a winding direction of the flat cable in the inner circumferential passage and that of the flat cable in the outer circumferential passage are inverted to each other. An intermediate portion of each roller is rotatably held by the rin, and a lower face of the roller is slidably contacted with the bottom plate section.

### BACKGROUND OF THE INVENTION

1. Field of the Invention

The present invention relates to a cable reel incorporated into a steering device of an automobile. More particularly, the present invention relates to a cable reel, the thickness of which is small, capable of rotating smoothly.

2. Description of the Related Art

Recently, there has been provided a cable reel in which a flat cable accommodating chamber formed as an annular hollow section is disposed. The annular hollow section is formed between a stationary body fixed onto a steering column side and a movable body fixed onto a steering shaft side. A flat cable is movably accommodated and inverted in the flat cable accommodating chamber, and a plurality of rollers are arranged in the annular hollow section as rotary guide members to guide the flat cable.

For example, as shown in FIG. 10, a stationary body 1, which serves as an outer cylinder and includes an outer frame 1a and a bottom plate 1b, and a movable body 2, which serves as an inner cylinder, are relatively rotatably connected with each other. A base plate 4 is rotatably set on the bottom plate 1b in the annular hollow section 8 that is formed between the stationary body 1 and the movable body 2. A group of rollers 5 are supported by pins 4b protruded from the base plate 4. The flat cable 3 is wound around the inner circumferential passage 6 formed between the rollers 5 and the inner cylinder 2a of the movable body 2, and is also wound around the outer circumferential passage 7 formed between the rollers 5 and the outer frame 1a of the stationary body 1, while the flat cable 3 is inverted and formed into a U-shape. One end of the flat cable 3 is fixed at the stationary body 1, and the other end of the flat cable 3 is fixed at the movable body 2.

In the above cable reel, when the movable body 2 is rotated in one direction, the flat cable 3, which is inverted and formed into a U-shape, passes an inversion section formed between the rollers 5, and the flat cable 3 is wound into the inner circumferential passage 6. On the other hand, when the movable body 2 is rotated in the opposite direction, the flat cable 3 is wound back and sent out to the outer circumferential passage 7.

Compared with a cable reel in which a flat cable is spirally wound in an accommodating space, the aforementioned inversion type cable reel is advantageous in that the length of the flat cable can be reduced.

However, the following problems may be encountered in the above cable reel shown in FIG. 10. In order to support the rollers 5 accommodated in the annular hollow section 8 while leaving a space between the rollers, the base plate 4 is set being engaged with a groove 1c formed on the bottom plate 1b. Therefore, thickness of the bottom plate 1b is increased. Accordingly, the overall height H of the cable reel is increased, which makes the cable reel size large.

Further, since the pins 4b for holding rollers 5 are protruded from the base plate 4 at predetermined positions, the structure becomes complicated and the size of the cable reel is increased, and further the material cost is raised. Furthermore, in the case where a bolt rotatably penetrates the axial center of each roller so as to prevent the roller from coming out, the number of parts and the number of working steps are increased corresponding to the number of rollers.

Japanese Unexamined Patent Publication No. 2000-215960 discloses a cable reel shown in FIG. 11. In this cable reel, an axis of the roller 5′ is made to be horizontal and tilted a little, an outer circumferential face 5a′ of the roller 5 is slidably contacted with the bottom plate 1b, and portions of the right 5c′ and the left end face 5b′ of the roller 5 are made to come into contact with the flat cable 3. The intermediate small diameter portion 5b′ of each roller 5 is rotatably supported by the bearing section 9b protruding downward from the guide ring 9 which is arranged being elastically contacted with the roof plate by the spring 9a.

The cable reel shown in FIG. 11 has the following disadvantages. Since the axis of the roller 5′ is set in the horizontal direction and tilted, the roller 5′ is unstable. Further, a profile of the guide ring 9 is complicated. The roller is positioned and held by the spring 9a protruding from the roof plate, and an outer circumferential face of the supported roller is slidably contacted with the bottom plate. Therefore, an intensity of torque required for the roller is increased, and the roller can not be smoothly rotated. As a result, the flat cable coming into contact with the roller can not be smoothly rotated.

### SUMMARY OF THE INVENTION

The present invention has been accomplished to solve the above problems. An object of the present invention is to provide a cable reel having an improved roller supporting mechanism so as to reduce the costs of parts and the number of working steps. The cable reel has a small thickness and lower rotating torque.

In order to solve the above problems, the present invention provides a cable reel comprising: a cylindrical stationary body and a movable body combined with each other to define an outer cylindrical section, inner cylindrical section, bottom plate section and roof plate section surrounding an annular hollow section; a guide member disposed in the annular hollow section, the guide member including a C-shaped ring and a plurality of rollers spaced apart from each other and rotatably supported by the ring; a flat cable having one end fixed at the movable body and the other end fixed at the stationary body, the flat cable wound round an inner circumferential passage formed between the inner cylindrical section and the rollers and wound round an outer circumferential passage formed between the outer cylindrical section and the rollers, wherein a winding direction of the flat cable in the inner circumferential passage is inverted to that of the flat cable in the outer circumferential passage; bearing holes are formed in the ring in the circumferential direction at intervals, each roller is formed into a substantial bobbin-shape having an annular recess portion between an upper and a lower large diameter portions, each roller is rotatably held by the bearing hole when the annular recess portion is inserted into the bearing hole; outer circumferential sections of the upper and the lower large diameter portions of the roller are protruded from an outer circumferential edge of the ring, and a lower end of the roller is slidably contacted with the bottom plate section of the stationary body.

When the above structure is adopted, the ring for holding the rollers is neither arranged below the rollers like the conventional example nor arranged above the rollers like the conventional example, but the ring is arranged in an intermediate portion. Therefore, the thickness of the guide member for guiding the flat cable is determined by only the roller thickness (roller height). Accordingly, the thickness of a product can be reduced.

The ring is formed into a flat plate shape, and the annular recess portions of the rollers can be rotatably held by the bearing holes formed on the flat plate. Therefore, unlike the conventional example, it is unnecessary to protrude pins and bearing sections from the ring, that is, the ring can be formed into a simple shape.

Circumferential faces of the upper and the lower large diameter portion of each roller are made to come into contact with at least the flat cable passing through the inner circumferential passage.

When the circumferential faces of the upper and the lower large diameter portion of each roller are made to come into line-contact with an upper and a lower portion of the flat cable, each roller can be easily given torque from the flat cable.

It is preferable that an annular groove is formed on an upper face of the bottom plate, and a lower end face of the roller is engaged with a bottom face of the annular groove.

When the roller is turned in the groove as described above, the roller is not idly moved in the radial direction. Therefore, the occurrence of rattle and the generation of noise can be prevented.

It is preferable that lubricant is coated or a sliding sheet is stuck on the upper face of the bottom plate or on the bottom face of a groove formed on the bottom plate.

When the sliding property of the face, on which the roller slides, is enhanced as described above, it is possible to reduce contact resistance. In this connection, when the sliding sheet is stuck, it is preferable that an elastic sheet is put on the reverse face of the sliding sheet, because the sliding noise can be absorbed and the occurrence of noise can be reduced by the elastic sheet.

When a conical recess portion is formed on the lower end face of the roller, and a protruding outer circumferential edge is made to come into line-contact with a groove bottom face formed on an upper face of the bottom plate or the bottom plate, the contact area can be reduced and contact resistance can be more reduced.

Each bearing hole formed in the ring is communicated with a roller insertion passage which is open to an inner circumferential edge or outer circumferential edge of the ring, width of the roller insertion passage is a little smaller than an outer diameter of the annular recess portion of the roller, the annular recess portion of the roller is forcibly inserted into the roller insertion passage, and after the annular recess portion of the roller has been forcibly inserted into the roller insertion passage, the roller insertion passage is returned to its initial shape so that the roller can be prevented from coming out.

When the above structure is adopted, the roller can be attached to the ring by one-touch motion. Therefore, the assembling property can be more enhanced.

It is preferable that a thick portion is formed in the circumferential edge of each bearing hole of the ring, and the thick portion is contacted with opposing faces of the upper and the lower large diameter portion of the roller.

When the above structure is adopted, the occurrence of rattle between the ring and the roller can be prevented.

Each bearing hole of the ring is formed into a through-hole, the roller is divided into two rollers at the annular recess portion, one is an upper roller, the other is a lower roller, a small diameter shaft is protruded from an upper face of the lower roller so that it is formed into the annular recess portion, an engaging pawl is protruded from a forward end of the small diameter shaft, the upper roller is formed into a cylinder, on the bottom face of which an engaging hole is formed, and after the small diameter shaft of the lower roller is inserted into the bearing hole, it is engaged with the engaging hole of the upper roller so as to integrate the upper roller with the lower roller into one body.

When the above structure is adopted, the roller can be simply attached into the bearing hole composed of a through-hole, and further it is possible to positively prevent the roller from coming out.

In this connection, instead of dividing the roller into two pieces of rollers, one is an upper roller and the other is a lower roller, it is possible to abolish the upper roller and compose the roller only of the lower roller.

A small diameter shaft is protruded from an upper end face of each roller, an engaging pawl is provided at a forward end of the small diameter shaft, bearing holes are formed in the ring in the circumferential direction at intervals, the small diameter shaft of each roller is inserted into the bearing hole so as to engage the engaging pawl with a circumferential edge of the bearing hole, an outer circumferential section of the roller is protruded from an outer circumferential edge of the ring, and a lower end of the roller is slidably contacted with a bottom plate section of the stationary body.

The height of the roller is not less than ½ of the height of the annular hollow section.

When the roller is composed as described above, it is possible to compose the roller of one member and downsize the roller. Therefore, this roller can be preferably applied to a case in which the flat cable width is small.

A spring may be protruded from an outside circumferential edge of the bearing hole provided in the ring, and the lower large diameter portion of the roller or the lower roller may be pushed downward by the spring.

When the spring is provided as described above, the occurrence of rattle in the sliding section between the roller and the bottom plate can be suppressed. Therefore, the roller can be smoothly rotated, and the generation of noise can be prevented.

### BRIEF DESCRIPTION OF THE DRAWINGS

FIG. 1 is an exploded perspective view of a cable reel of a first embodiment of the present invention.

FIGS. 2A and 2B are sectional views of a cable reel of the first embodiment.

FIG. 3 is a front view of a roller of the first embodiment.

FIG. 4A is a plan view of a ring of the first embodiment, FIG. 4B is an enlarged view showing a primary portion, and FIG. 4C is a sectional view taken on line I-I in FIG. 4A.

FIG. 5 is a plan view of a ring of a second embodiment.

FIG. 6 is an exploded sectional view of a roller of the second embodiment.

FIG. 7 is a sectional view of a third embodiment.

FIG. 8 is a sectional view of a fourth embodiment.

FIG. 9 is a sectional view of a fifth embodiment.

FIG. 10 is a sectional view of a conventional reel.

FIG. 11 is a sectional view of another conventional reel.

### DETAILED DESCRIPTION OF THE PRESENT INVENTION

Referring to the drawings, embodiments of the present invention will be explained below.

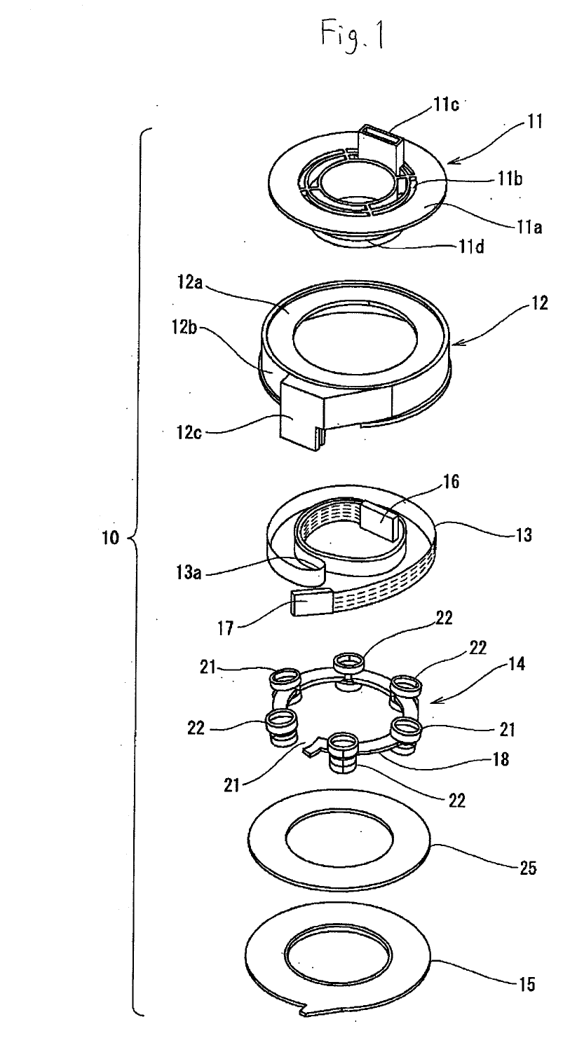

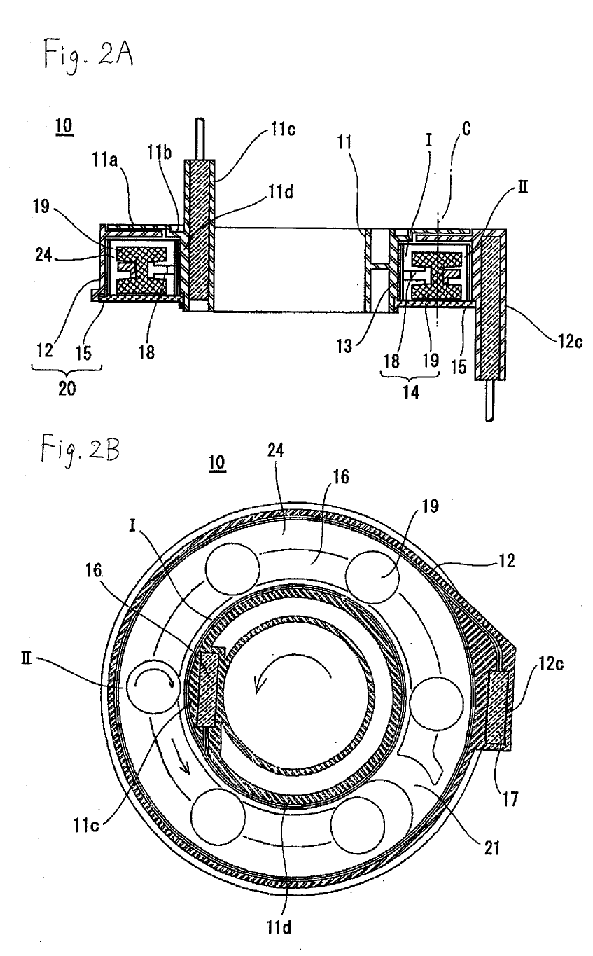

FIGS. 1 to 4B are views showing a first embodiment.

In the cable reel 10 of the first embodiment, the stationary body 20, which constitutes an outer cylinder, having an outer frame 12 and bottom plate 15, and the movable body 11, which becomes an inner cylinder, are connected with each other being capable of relatively rotating.

The movable body 11 includes: an inner cylindrical section 11d which becomes an inner cylinder; a first roof plate section 11a, the shape of which is annular, protruding from an upper end of the inner cylinder section 11d being formed into a flange-shape; an annular recess portion 11b provided in the first roof plate section 11a on the inner cylinder 11d side; and a connector accommodating section 11c protruding upward from an upper end of the inner cylinder section 11d.

The outer frame 12 of the stationary body 20 includes: an outer cylinder section 12b which becomes an outer cylinder; a second roof plate section 12a, which is formed annular, protruding inward from an upper end of the outer cylinder section 12b; and a connector accommodating section 12c protruding downward from an outer face of the outer cylinder section 12b. The bottom plate 15 is an annular plate which becomes a bottom plate section of the cable reel 10. This bottom plate section 15 is locked and fixed at the outer frame 12.

The sliding sheet 25, which is composed of an elastic sheet and sliding film which are made to adhere to each other, is stuck on an upper face of the bottom plate 15.

In the annular hollow section 24 formed between the movable body 11 and the stationary body 20, there is rotatably provided a guide member 14 in which six rollers 19 are attached to the C-shaped ring 18 at regular intervals.

Inside the annular hollow section 24, the flat cable 13, one connector 16 of which is engaged with the connector accommodating section 11c of the movable body 11, is wound around the inner circumferential passage I formed between the inner circumferential side of the guide member 14 and the outer circumferential face of the inner circumferential wall 11d of the movable body 11. While an intermediate portion of the flat cable 13 is determined to be an inversion section 13a, the flat cable 13 is threaded into the inversion space 21 formed between the end portions of the ring 18 of the guide member 14. Then, the flat cable 13 is wound back in the outer circumferential passage II formed between the outer circumferential side of the guide member 14 and the inner circumferential face of the outer cylinder section 12b. The connector 17 of the other end of the flat cable 13 is accommodated in the connector accommodating section 12c of the upper case 12.

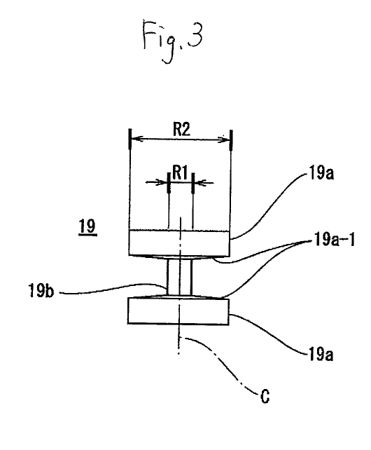

As shown in FIG. 3, the roller 19 is formed into a bobbin-shape in which the annular recess portion 19b in the intermediate section in the axial direction is interposed between the upper and the lower large diameter portion 19a. The opposing faces 19a-1 of the upper and the lower large diameter portion 19a are protruded from the outer circumferences being tapered, and the central portions are flat.

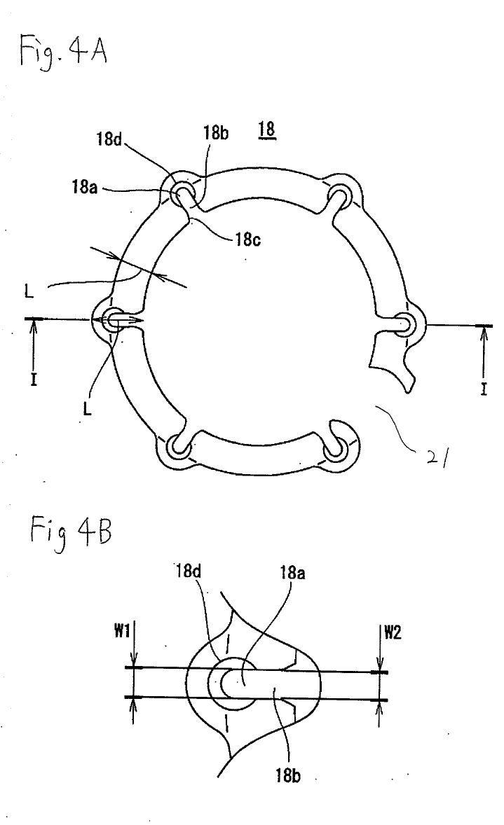

As shown in FIG. 4A, the ring 18 is formed into a C-shape having the inversion space 21. In the ring 18, there are provided six bearing holes 18a which are located in the circumferential direction at regular intervals. The outer circumferential portion of this bearing hole 18a is formed into the thick portion 18d, which comes into contact with the tapered portion 19a-1 of the upper and the lower large diameter portion 19a of the roller 19.

Each bearing hole 18a is cut out and opened at the inner circumferential end of the ring 18 and communicated with the roller insertion section 18b.

Width W1 of the bearing hole 18a shown in FIG. 4B is set to be a little larger than outer diameter R1 of the annular recess portion 19b of the roller 19. On the other hand, width W2 of the roller insertion section 18b is set to be a little smaller than outer diameter R1 of the annular recess portion 19b of the roller 19, and the entrance section 18c open at the inner circumferential end of the roller insertion section 18b is expanded being tapered.

When the roller 19 is incorporated into the ring 18, the annular recess portion 19b of the roller 19 is slid and inserted from the roller insertion passage 18b of the ring 18. Therefore, the annular recess portion 19b of the roller 19 can penetrate the bearing hole 18a by one-touch motion. In this way, the roller 19 can be rotatably held by the ring 18. When width W2 of the roller insertion passage 18b is made to be a little smaller than outer diameter R1 of the annular recess portion 19b of the roller 19, the roller 19 can be prevented from coming out.

Axis C of the bearing hole 18a is set in the same direction as that of the normal line of the bottom plate 15.

In this case, the inequality of L2<L1<R2 is established, wherein L1 is the width of a portion of the ring 18 in which the bearing hole 18a is formed, L2 is the width of the other portions of the ring 18 and R2 is the outermost diameter of the roller 19. Therefore, the outer circumferential face of the roller 19 is protruded from the outer circumferential face and the inner circumferential face of the ring 18.

The above guide member 14 is accommodated in the annular hollow section 24, and a lower face of the lower large diameter portion 19a of the roller 19 is set on the sliding sheet 25 on the bottom plate 15. When the components are set as described above, axis C of the roller 19 is set in the same direction as that of the normal line of the bottom plate 15, that is, axis C of the roller 19 is set in the vertical direction. Therefore, circumferential faces of the upper and the lower large diameter portion 19a of the roller 19 come into line-contact with the upper and the lower portion of the flat cable 13 on the side of inner circumferential passage I.

Next, operation of the cable reel 10 will be explained below.

When a steering shaft (not shown) is rotated, the movable body 11 is rotated in one direction (clockwise). Then the flat cable 13 is wound up. Therefore, the flat cable 13 in the outer circumferential passage II passes through the inversion space 21 being folded back, so that the flat cable 13 is wound up around the inner circumferential passage I. On the other hand, when the movable body 11 is rotated in the reverse direction (counterclockwise), the flat cable 13 is wound back. Then, the flat cable 13 in the inner circumferential passage I passes through the inversion space 21 being folded back, so that the flat cable 12 is sent out to the above outer circumferential passage II.

Since the flat cable 13 in the inner circumferential passage I comes into contact with the roller 19 when the flat cable 13 is rotated, the roller 19 is also rotated. Therefore, frictional resistance of the roller 19 with the flat cable 13 is reduced. As a result, the torque can be reduced.

When the intermediate portion of each roller 19 is held by the ring 18, it is unnecessary to provide a base plate which is conventionally attached to the bottom plate. Therefore, the thickness of the cable reel can be reduced by the thickness of the base portion of the base plate.

Further, in order to hold the roller 19 by the ring 18, only the bearing hole 18a and the roller insertion passage 18b are formed in the ring 18. Therefore, it is unnecessary to provide a support pin protruding from the base plate which is needed in the conventional structure. Therefore, the structure can be made simple and thin as compared with the conventional base plate. Further, it is unnecessary to provide other parts such as bolts for holding the roller. Accordingly, the number of parts can be reduced, and the number of working steps for attaching the roller can be reduced.

In this connection, in this embodiment, the roller passage 18b is formed in the ring 18 by cutting out the inner circumferential side of the ring 18. Of course, the roller passage 18b may be formed in the ring 18 by cutting out the outer circumferential side of the ring 18.

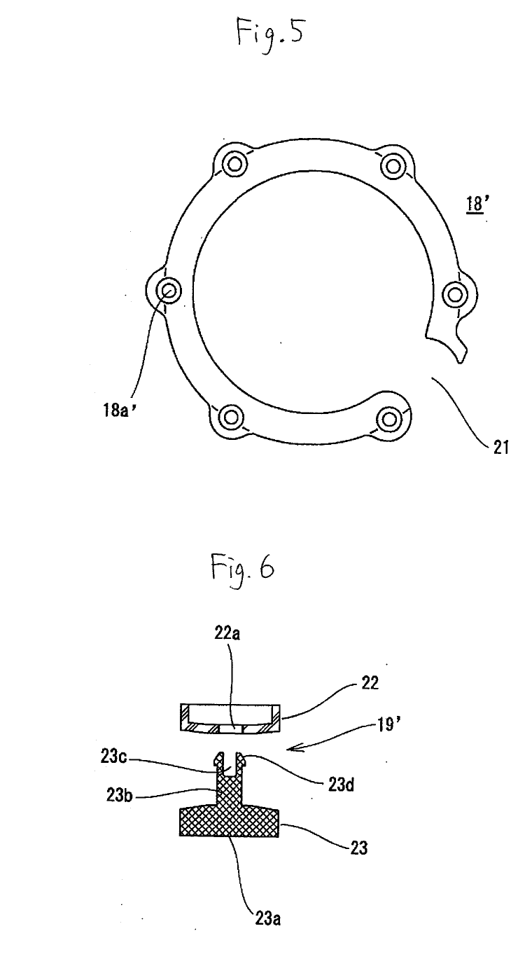

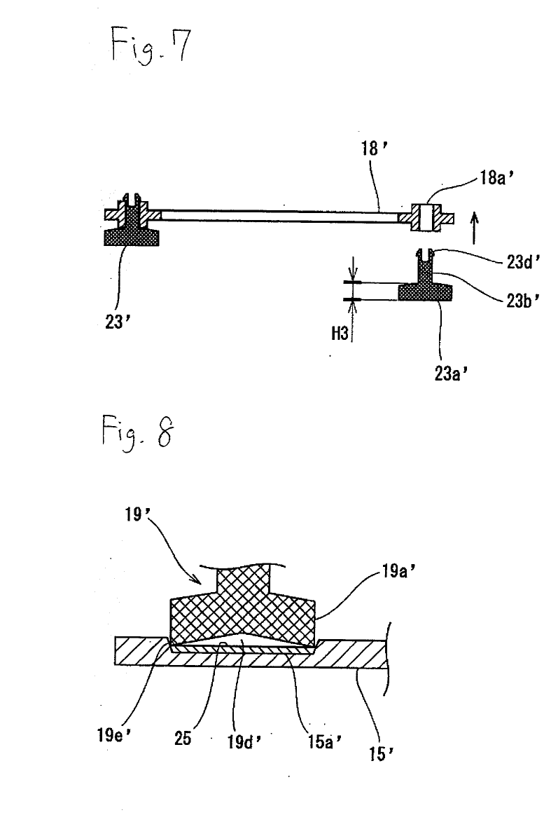

FIGS. 5 and 6 are views showing a second embodiment.

Different points of the second embodiment from the first embodiment are described as follows. The bearing holes 18a′ formed in the ring 18′ are through-holes which penetrate the ring 18′. There are provided no roller insertion sections into which the rollers are inserted from the side. Each roller 19′ is composed of two members which are attached into the bearing hole from the top and the bottom.

In the same manner as that of the first embodiment, the ring 18′ is formed into a C-shape having the inversion space 21, and six bearing holes 18a′ are formed in the circumferential direction at predetermined intervals.

At the intermediate annular recess portion, the roller 19′ is divided into the first roller 22 and second roller 23. In the first roller 22, which is arranged in an upper portion, there is provided an engaging hole 22a which is formed at the center of the bottom face of the large diameter cylindrical section. In the second roller 23, which is arranged in a lower portion, there is provided a small diameter shaft 23b which is protruded from the center of the upper face of the large diameter portion 23a. At an upper end of the shaft 23b, there is provided a recess portion 23c, and further there is provided an engaging pawl 23d which is protruded from the outer circumference of the recess portion 23c.

Concerning the above roller 19′, the shaft 23a of the second roller 23 is inserted into the bearing hole 18a′ from a lower portion while the recess portion 23c of the shaft 23a of the second roller 23 is being bent by the recess portion 23c. After that, the engaging pawl 23d is engaged with the engaging hole 22a of the first roller 22 so that the first 22 and the second roller 23 can be integrated with each other into one body. Due to the foregoing, the bearing hole 18a′ can be rotatably interposed between the first 22 and the second roller 23. The shape and size of the roller 19′, which is composed of the first 22 and the second roller 23, are the same as those of the roller 19 of the first embodiment. Concerning the ring 18′, except for a point at which the roller insertion section is not cut out, the shape and size the ring 18′ of this embodiment are the same as those of the first embodiment.

When the above structure is adopted, it is unnecessary to provide a roller insertion section communicated with the bearing insertion hole 18a′.

FIG. 7 is a view showing a variation of a third embodiment.

In the third embodiment, the first roller, which is a large diameter portion on the upper side, is abolished, and only the second roller 23′, which is a large diameter portion on the lower side, is provided. In this case, height H3 of the large diameter portion 23a of the second roller 23′ is approximately ½ of the height of the annular hollow section 24 when the second roller 23′ is attached to the annular hollow section 24.

The shape of the roller 23′ is substantially the same as that of the roller 23 of the second embodiment. However, the height of the small diameter shaft 23b′ of the roller 23′ is made a little larger than that of the bearing hole 18a.

The shaft 23b′ of the roller 23′ is inserted into the bearing hole 18a′ from a lower portion, and the engaging pawl 23d′ of the shaft 23b′ is rotatably engaged with an upper end edge of the bearing hole 18′a.

When the above structure is adopted, the roller 1 is composed of one member of the roller 23′. Therefore, the number of parts can be reduced and the number of working steps required for attaching the roller can be also reduced. Further, the roller weight can be reduced. Accordingly, the cable reel weight can be reduced.

FIG. 8 is a view showing a fourth embodiment.

Different points of the fourth embodiment from the first embodiment are described as follows. The annular groove 15a′ is formed on an upper face of the bottom plate 15′ of the stationary body, and the sliding sheet 25 is stuck onto the bottom face of the groove 15a. Further, the conical recess 19d′ is formed on the bottom face of the lower large diameter portion 19a′ of the roller 19.

The outer circumferential edge 19e′ of the conical recess 19d′ is made to come into line-contact with the inner and outer edges of the groove 15a′.

In this connection, the lower large diameter portion 19 may be formed into the same shape as that of the first embodiment, and a flat lower end face of the lower large diameter portion 19 may be made to come into line-contact with the groove 15a.

When the above structure is adopted, the outer circumferential edge 19e′ of the conical recess of the lower large diameter portion of the roller 19′ comes into line-contact with the inner and outer end edges of the groove 15a being caught. Therefore, it is possible to restrict the roller 19′ from idly moving in the radial direction. Accordingly, the generation of rattle and noise can be prevented, and a contact area of the roller 19′ with the bottom plate 15′ can be reduced, which reduces frictional resistance.

Other points of the structure are the same as those of the first embodiment. Therefore, like reference characters are used to indicate like parts, and explanations are omitted here.

In this connection, a groove may be also formed on the roof plate, and a sliding sheet may be stuck onto a bottom face of the groove. Further, an upper end face of the upper large diameter portion of the roller may be contacted with the sliding sheet on the bottom face of the groove. Alternatively, a conical recess is formed on the upper end face, and an outer circumferential end of the conical recess may be made to come into contact with the sliding sheet on the bottom face of the groove.

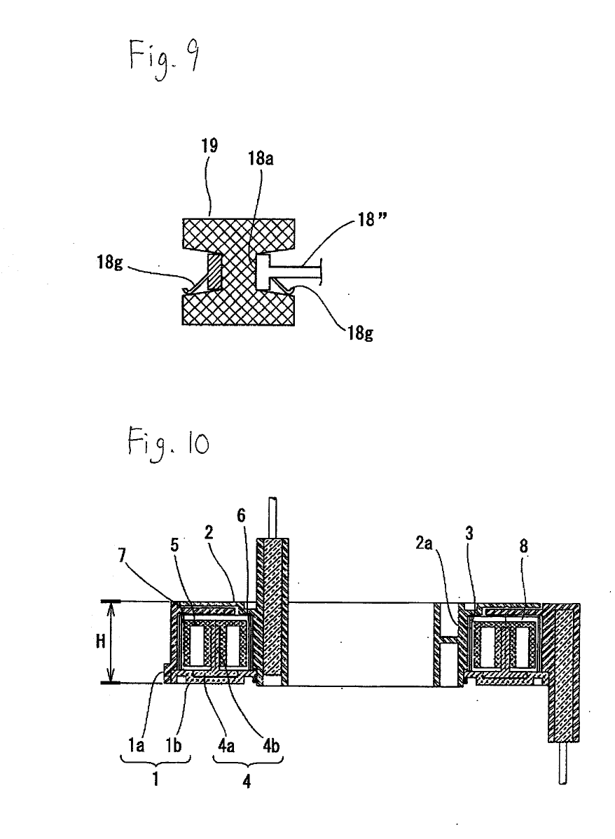

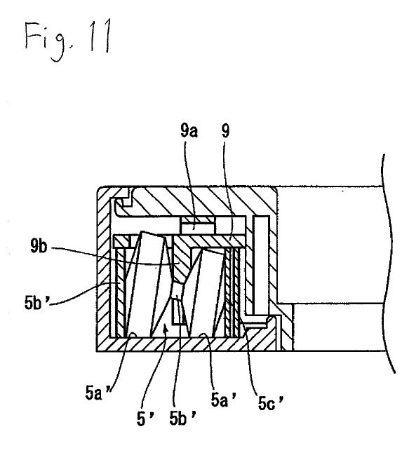

FIG. 9 is a view showing a fifth embodiment.

In the fifth embodiment, the spring 18g is protruded from an outer circumferential portion of the bearing hole 18a of the ring 18′ and made to come into pressure-contact with an upper end face of the lower large diameter portion 19a of the roller 19.

When the roller 19 is pushed downward by the spring 18g in this way, it is possible to prevent the occurrence of rattle between the roller and the ring 18′, and further a lower face of the roller 19 can be elastically contacted with the bottom plate.

As can be clearly seen in the above explanations, according to the present invention, the guide member for guiding the flat cable is attached to the ring at an intermediate portion of the roller in the axial direction. Therefore, compared with the conventional guide member in which the base plate is arranged on the bottom plate and the roller is supported by the pin protruding from the base plate, the base plate can be abolished. According to the abolition of the base plate, the thickness of the cable reel can be reduced.

When the annular recess portion of the above roller is rotatably engaged in the bearing hole of the ring, it becomes unnecessary to provide a protruding pin for holding the roller. Therefore, the material cost of the ring can be reduced, and further it is unnecessary to fasten the roller with a bolt. Only a worker has to do is to engage the annular recess portion of the roller in the bearing hole. Therefore, the number of parts can be reduced. As a result, the number of working mandays can be reduced.

The axis of the roller is made to agree with the direction of the normal line of the bottom plate, and the upper and the lower large diameter portion of the roller are set in the vertical direction. In the above state, the lower end face of the lower large diameter portion is slidably contacted with the bottom plate. Therefore, the roller can be stably positioned. Since the outer circumferential face of the roller is made to come into contact with the flat cable, the roller can be stably rotated. As a result, the flat cable can be smoothly rotated.

What is claimed is:

1. A cable reel comprising:
a stationary body;
a movable body combined with the stationary body to define an outer cylindrical section, an inner cylindrical section, a bottom plate section and a roof plate section surrounding an annular hollow section;
a guide member disposed in the annular hollow section, the guide member including a C-shaped ring and a plurality of rollers spaced apart from each other and rotatably supported by the ring; and
a flat cable having one end fixed at the movable body and the other end fixed at the stationary body, the flat cable wound round an inner circumferential passage formed between the inner cylindrical section and the rollers and wound round an outer circumferential passage formed between the outer cylindrical section and the rollers,
wherein a winding direction of the flat cable in the inner circumferential passage is inverted to that of the flat cable in the outer circumferential passage;
bearing holes are formed in the ring in the circumferential direction at intervals, each roller is formed into a substantial bobbin-shape having an annular recess portion between an upper and a lower large diameter portions, each roller is rotatably held by the bearing hole when the annular recess portion is inserted into the bearing hole;
outer circumferential sections of the upper and the lower large diameter portions of the roller are protruded from an outer circumferential edge of the ring, and a lower end of the roller is slidably contacted with the bottom plate section of the stationary body.

2. The cable reel as claimed in claim 1, wherein circumferential faces of the upper and the lower large diameter portions of each roller are contacted with the flat cable passing in the inner circumferential passage.

3. The cable reel as claimed in claim 1, wherein an annular groove is formed on an upper face of the bottom plate section, and a lower end face of the roller is engaged with a bottom face of the annular groove.

4. The cable reel as claimed in claim 1, wherein lubricant is coated or a sliding sheet is stuck onto an upper face of the bottom plate section slidably coming into contact with the roller.

5. The cable reel as claimed in claim 3, wherein lubricant is coated or a sliding sheet is stuck onto the bottom face of the groove formed on the upper face of the bottom plate section.

6. The cable reel as claimed in claim 1, wherein each bearing hole formed in the ring is communicated with a roller insertion passage which is open to an inner circumferential edge or outer circumferential edge of the ring, width of the roller insertion passage is a little smaller than an outer diameter of the annular recess portion of the roller, the annular recess portion of the roller is forcibly inserted into the roller insertion passage, and after the annular recess portion of the roller has been forcibly inserted into the roller insertion passage, the roller insertion passage is returned to its initial shape so that the roller can be prevented from coming out.

7. The cable reel as claimed in claim 1, wherein a thick portion is formed in a circumferential edge of each bearing hole of the ring, and the thick portion is contacted with opposing faces of the upper and the lower large diameter portions of the roller.

8. The cable reel as claimed in claim 1, wherein each bearing hole of the ring is formed into a through-hole, the roller is divided into two rollers at the annular recess portion, one is an upper roller, the other is a lower roller, a small diameter shaft is protruded from an upper face of the lower roller so that it is formed into the annular recess portion, an engaging pawl is protruded from a forward end of the small diameter shaft, the upper roller is formed into a cylinder, on the bottom face of which an engaging hole is formed, and after the small diameter shaft of the lower roller is inserted into the bearing hole, it is engaged with the engaging hole of the upper roller so as to integrate the upper roller with the lower roller into one body.

9. A cable reel comprising:
a stationary body;
a movable body combined with the stationary body to define an outer cylindrical section, an inner cylindrical section, a bottom plate section and a roof plate section surrounding an annular hollow section;
a guide member disposed in the annular hollow section, the guide member including a C-shaped ring and a plurality of rollers spaced apart from each other and rotatably supported by the ring; and
a flat cable having one end fixed at the movable body and the other end fixed at the stationary body, the flat cable wound round an inner circumferential passage formed between the inner cylindrical section and the rollers and wound round an outer circumferential passage formed between the outer cylindrical section and the rollers,
wherein a winding direction of the flat cable in the inner circumferential passage is inverted to that of the flat cable in the outer circumferential passage;
a small diameter shaft is protruded from an upper end face of each roller, an engaging pawl is provided at a forward end of the small diameter shaft,
bearing holes are formed in the ring in the circumferential direction at intervals, the small diameter shaft of each roller is inserted into the bearing hole so as to engage the engaging pawl with a circumferential edge of the bearing hole, an outer circumferential section of the roller is protruded from an outer circumferential edge of the ring, and a lower end of the roller is slidably contacted with a bottom plate section of the stationary body.

10. The cable reel as claimed in claim 9, wherein the height of the roller is not less than ½ of the height of the annular hollow section.

11. The cable reel as claimed in claim 9, wherein a conical recess portion is formed on the lower end face of the roller, and a protruding outer circumferential edge is made to come into line-contact with the bottom plate section or a bottom face of a groove formed on an upper face of the bottom plate section.
